(19) United States
(12) Patent Application Publication
(10) Pub. No.: US 2010/0181536 A1
(43) Pub. Date: Jul. 22, 2010

(54) Aqueous Solutions of Optical Brighteners

(75) Inventors: Mariela Gauto, Bradford (GB); Andrew Clive Jackson, Harrogate (GB); Alec Stewart Tindal, Leeds (GB)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant Finance (BVI) Limited, Tortola (VG)

(21) Appl. No.: 12/376,672

(22) PCT Filed: Jul. 31, 2007
(86) PCT No.: PCT/EP07/57909

§ 371 Date: Feb. 6, 2009

(51) Int. Cl. C09K 11/06

(52) U.S. Cl. 252/301.23

(57) ABSTRACT

The instant invention relates to storage stable aqueous optical brightener/PVOH solutions of low viscosity which may be used directly by the papermaker, in that they can be metered by pump directly into a coating composition, and which provide coated papers of a surprisingly high whiteness

The instant invention relates to aqueous solutions of optical brighteners with polyvinyl alcohols which can be directly used by the papermaker and which provide coated papers of high whiteness.

It is well known that the whiteness and thereby the attractiveness of coated papers can be improved by the addition of optical brighteners to the coating composition. In order to satisfy the demand for coated papers of higher whiteness, there is a need for more efficient optical brighteners.

Even though it is known that polyvinyl alcohol (PVOH) can boost the performance of optical brighteners in pigmented coating compositions by acting as a carrier (see, for example, page 164 of “Surface Application of Paper Chemicals” by Brander (Springer, 1997)), the papermaker, when wanting to use said alcohol, has had to add it separately to the coating composition, typically in the form of an aqueous solution, resulting in a higher water content of the coating composition and consequently longer drying times. The problem of providing the papermaker with an entirely satisfactory means of using PVOH as a carrier for optical brighteners remains.

WO 2005/056658 seeks to provide a solution by disclosing a method of preparing an optical brightener/PVOH aqueous concentrate comprising the sequential steps of: (a) providing an aqueous brightener composition including water and optical brightener active ingredient, wherein the optical brightener active ingredient is typically present in the aqueous brightener composition in an amount of from about 10% to about 25%; (b) admixing a polyvinyl alcohol resin with said optical brightener composition in an amount of about 1 part of dry polyvinyl alcohol resin per 0.25 to 10 wet parts of aqueous brightener composition to provide a nascent aqueous concentrate of polyvinyl alcohol resin and optical brightener; and (c) cooking the aqueous concentrate to dissolve the solids (i.e., to give an aqueous solution containing optical brightener and 9.1-80% polyvinyl alcohol). The method allows the preparation of pigmented coating compositions with lower water content without compromising brightness and colour. WO 2005/056658 does not however provide a satisfactory solution for the papermaker, who would typically wish to meter the optical brightener/PVOH solution directly into the coating composition; aqueous solutions containing optical brightener and more than 9% PVOH are generally of such high viscosity that they can be pumped only with difficulty, if at all. Papermakers are typically not able to use liquids with a viscosity greater than 1,000 mPa·s not only because of pumping difficulties, but also because of shock thickening when a liquid of such high viscosity is introduced to the coating composition.

The problem of providing an optical brightener/PVOH aqueous solution which combines good brightening ability with low viscosity remains to be solved.

It has now been found that it is possible to produce optical brightener/PVOH solutions of low viscosity which may be used directly by the papermaker, in that they can be metered by pump directly into a coating composition, and which provide coated papers of a surprisingly high whiteness.

The invention thus provides aqueous optical brightener solutions consisting essentially of
(a) between 10 and 50% by weight of at least one optical brightener of formula (1)

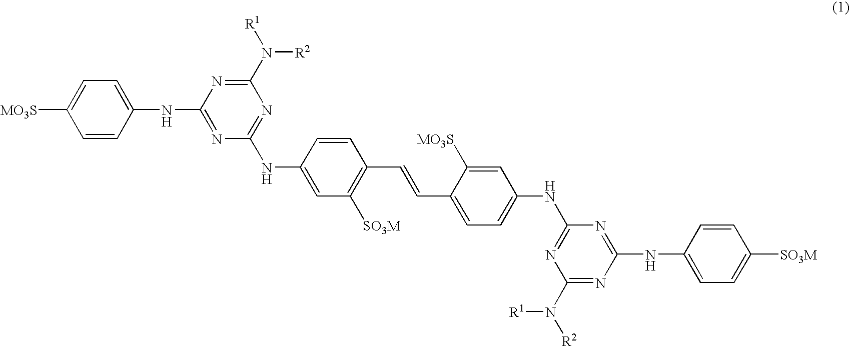

in which
M is hydrogen, an alkali metal atom, ammonium or a cation derived from an amine, preferably hydrogen or sodium, most preferably sodium,
R¹ is hydrogen, C₁-C₄ alkyl or C₂-C₄ hydroxyalkyl, and
R² is C₁-C₄ alkyl which may be substituted by a —CN or —CONH₂ group or C₂-C₄ hydroxyalkyl, or
R¹ and R² together with the nitrogen atom complete a morpholino ring;
(b) between 0.5 and 9% by weight of polyvinyl alcohol having a degree of hydrolysis of from 60 to 85%; and
(c) water.
   NR¹R² is preferably N(CH₂CH₂OH)₂, N(CH₂CH(CH₃)OH)₂, N(CH₂CH₂OH)CH₂CH₂CONH₂, or N(CH₂CH(CH₃)OH)CH₂CH₂CONH₂, and most preferably is N(CH₂CH₂OH)₂ or N(CH₂CH(CH₃)OH)₂.

The aqueous solutions may contain up to 10% by weight of salt, typically sodium chloride, formed as a by-product from the production of the optical brightener.

The aqueous solutions may also contain one or more antifreezes, biocides, complexing agents or other additives, as well as organic by-products formed during the preparation of the optical brightener. The aqueous solution may also contain other carriers, such as polyethylene glycol.

The polyvinyl alcohol preferably has a degree of hydrolysis of from 65 to 80% and a Brookfield viscosity of 2-40 mPa·s (4% aqueous solution at 20° C.). More preferably, the polyvinyl alcohol has a degree of hydrolysis in the range 65-75% and a Brookfield viscosity of 2-20 mPa·s (4% aqueous solution at 20° C.).

Preferably the polyvinyl alcohol content of the solution lies in the range 1 to 5%, more preferably in the range 1.5 to 4% by weight of the solution.

The concentration of the optical brightener in the solution is preferably in the range 15 to 40%, more preferably in the range 18 to 35% by weight of the solution.

The optical brightener/PVOH solutions are typically made by adding the polyvinyl alcohol as a solid to a stirred solution of the optical brightener in water, and heating to 90-95° C. until a clear solution forms.

The pH of the aqueous solution is preferably from neutral to clearly alkaline, in particular in the range pH 7 to pH 10. The pH may, if necessary, be adjusted by addition of M-corresponding bases, e.g. alkali metal hydroxides or carbonates, ammonia or amines.

The optical brightener/PVOH solutions of the invention are storage-stable and may be used directly as such, in that they may be metered by pump directly into a coating composition. Thus a further object of the invention is the addition of the brightener/PVOH solutions to coating compositions in order to obtain a coated and optically brightened paper.

Thus, the invention also provides a process for the production of coated paper that is optically brightened at least in the coating, wherein a coating composition as described above is coated onto paper after sheet formation.

The coating compositions are essentially aqueous compositions that contain at least one binder and a white pigment, in particular an opacifying white pigment, and may additionally contain further additives such as dispersing agents, defoamers and synthetic thickeners.

Although it is possible to produce coating compositions that are free from white pigments, the best white substrates for printing are made using opaque coating compositions that contain 10-70% white pigment by weight. Such white pigments are generally inorganic pigments, e.g., aluminium silicates (kaolin, otherwise known as china clay), calcium carbonate (chalk), titanium dioxide, aluminium hydroxide, barium carbonate, barium sulphate, or calcium sulphate (gypsum).

The binders may be any of those commonly used in the paper industry for the production of coating compositions and may consist of a single binder or of a mixture of primary and secondary binders. The sole or primary binder is preferably a synthetic latex, typically a styrene-butadiene, vinyl acetate, styrene acrylic, vinyl acrylic or ethylene vinyl acetate polymer. The secondary binder may be, e.g., starch, carboxymethylcellulose, casein, soy polymers, polyvinyl alcohol or a mixture of any of the above.

The sole or primary binder is used in an amount typically in the range 5-25% by weight of white pigment. The secondary binder is used in an amount typically in the range 0.1-10% by weight of white pigment.

The optical brightener of formula (1) is used in an amount typically in the range 0.01-1% by weight of white pigment, preferably in the range 0.05-0.5% by weight of white pigment.

### EXAMPLES

The following examples shall explain the instant invention in more detail. If not indicated otherwise, “%” and “parts” are by weight; viscosities are measured using a Brookfield viscometer.

### Preparative Example 1

Optical brightener solution 1 is produced by stirring together
25.9 parts of an optical brightener of formula (2),
72.0 parts of water, and
2.1 parts of a polyvinyl alcohol having a degree of hydrolysis of 71% and a Brookfield viscosity of 5.4 mPa·s (4% aqueous solution at 20° C.)
   while heating to 90-95° C., until a clear solution is obtained that remains stable after cooling to room temperature. The pH of the solution is adjusted to 9.0 with sodium hydroxide.

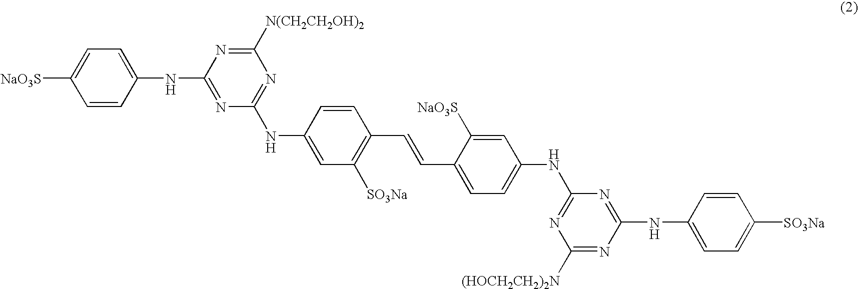

The viscosity of the solution is 97 mPa·s at 20° C. and 211 mPa·s at 10° C.

### Preparative Example 2

### Comparative Example

### Without Polyvinyl Alcohol

Optical brightener solution 2 is produced by stirring together
25.9 parts of an optical brightener of formula (2), and
74.1 parts of water. The pH of the solution is adjusted to 9.0 with sodium hydroxide.

### Application Example

A coating composition is prepared containing 500 parts chalk (commercially available under the trade name Hydrocarb 90 from OMYA), 500 parts clay (commercially available under the trade name Kaolin SPS from IMERYS), 470 parts water, 6 parts dispersing agent (a sodium salt of a polyacrylic acid commercially available under the trade name Polysalz S from BASF), 200 parts of 50% latex (a styrene butadiene copolymer commercially available under the trade name DL 921 from Dow) and 50 parts of a 10% solution of carboxymethyl cellulose (commercially available under the trade name Finnfix 5.0 from Noviant) in water. The solids content is adjusted to 60% by the addition of water, and the pH is adjusted to 8-9 with sodium hydroxide.

Optical brightener solutions 1 and 2, made as described in Preparative Examples 1 and 2 respectively, are added at a range of concentrations from 0.4 to 1.0% by weight of dry solids to the stirred coating composition. The brightened coating composition is then applied to a commercial 75 gsm neutral-sized white paper base sheet using an automatic wire-wound bar applicator with a standard speed setting and a standard load on the bar. The coated paper is then dried for 5 minutes in a hot air flow. The dried paper is allowed to condition, then measured for CIE Whiteness on a calibrated Elrepho spectrophotometer.

TABLE 1

| Conc. of OBA | Conc. of OBA | | CIE Whiteness |
|---|---|---|---|
| soln. by weight | (2) by weight of | CIE Whiteness | using soln. 2 |
| of dry solids (%) | dry solids (%) | using soln. 1 | (Comparative) |
| 0.4 | 0.104 | 88.7 | 86.9 |
| 0.6 | 0.155 | 89.9 | 88.2 |
| 0.8 | 0.207 | 91.8 | 89.1 |
| 1.0 | 0.259 | 92.7 | 88.5 |

The instant results clearly show the surprising superiority in whiteness of coated papers made using the instant solutions which contain only 2.1% polyvinyl alcohol by weight.

### Preparative Examples 3-5

Optical brightener solutions 3-5 containing 12.3% active brightener are produced by stirring together
12.3 parts of an optical brightener of formula (2),
(87.7-x) parts of water, and
x parts of a polyvinyl alcohol having a degree of hydrolysis of 85.2% and a Brookfield viscosity of 3.7 mPa·s (4% aqueous solution at 20° C.)
   while heating to 90-95° C., until a clear solution is obtained that remains stable after cooling to room temperature. The pH of each solution is adjusted to 9.0 with sodium hydroxide. The viscosity of each solution is recorded in Table 2.

TABLE 2

| | PVOH conc. | | |
|---|---|---|---|
| | by weight of | Viscosity | Viscosity |
| Example Number | solution (%) | (20° C.) | (10° C.) |
| 3 | 3.2 | 21.6 | 34.4 |
| 4 | 6.3 | 123.5 | 256.4 |
| 5 (Example of WO | 9.5 | 4269 | 5089 |
| 2005/056658) | | | |

The instant results clearly show the advantage of the instant solutions in terms of lower viscosity, and consequently pumpability.

1. An aqueous optical brightener solution consisting essentially of
(a) between 10 and 50% by weight of at least one optical brightener of formula (1) 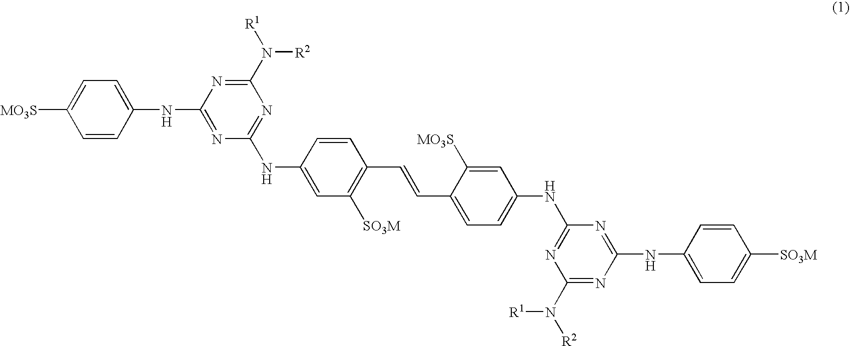
in which
M is hydrogen, an alkali metal atom, ammonium or a cation derived from an amine,
R¹ is hydrogen, C₁-C₄ alkyl or C₂-C₄ hydroxyalkyl, and
R² is C₁-C₄ alkyl which may be substituted by a —CN or —CONH₂ group or C₂-C₄ hydroxyalkyl, or
R¹ and R² together with the nitrogen atom complete a morpholino ring;
(b) between 0.5 and 9% by weight of polyvinyl alcohol having a degree of hydrolysis of from 60 to 85%; and
(c) water.

2. An aqueous optical brightener solution according to claim 1 wherein
M is sodium,
NR¹R² is N(CH₂CH₂OH)₂, N(CH₂CH(CH₃)OH)₂,
N(CH₂CH₂OH)CH₂CH₂CONH₂, or
N(CH₂CH(CH₃)OH)CH₂CH₂CONH₂, and
wherein the polyvinyl alcohol has a degree of hydrolysis of from 65 to 80% and a Brookfield viscosity of 2-40 mPa·s.

3. An aqueous optical brightener solution according to claim 1 wherein
M is sodium,
NR¹R² is N(CH₂CH₂OH)₂ or N(CH₂CH(CH₃)OH)₂, and
wherein the polyvinyl alcohol has a degree of hydrolysis of from 65 to 75% and a Brookfield viscosity of 2-20 mPa·s.

4. An aqueous optical brightener solution according to claim 1, wherein the concentration of the polyvinyl alcohol is from 1 to 5% by weight and wherein the concentration of the optical brightener is from 15 to 40% by weight.

5. An aqueous optical brightener solution according to claim 1 wherein the concentration of the polyvinyl alcohol is from 1.5 to 4% by weight and wherein the concentration of the optical brightener is from 18 to 35% by weight.

6. A coating composition for paper comprising at least one aqueous optical brightener solution according to claim 1.

7. A process for the production of a coated paper comprising the step of coating a paper after sheet formation with a coating composition containing at least one aqueous optical brightener solution according to claim 1.

8. A process according to claim 7 wherein the coating composition further contains from 10 to 70% by weight of one or more white pigments.

9. A process according to claim 7 wherein the coating composition further contains a primary binder based on synthetic latex selected from styrene-butadiene, vinyl acetate, styrene acrylic, vinyl acrylic or ethylene vinyl acetate polymer or additionally a secondary binder selected from starch, carboxymethylcellulose, casein, soy polymers, or polyvinyl alcohol or a mixture of any of the above.

10. A process according to claim 9 wherein the primary binder is used in an amount from 5 to 25% by weight of white pigment, wherein the secondary binder is used in an amount from 0.1 to 10% by weight of white pigment and wherein the optical brightener of formula (1) is used in an amount from 0.01 to 1% by weight of white pigment.

11. A process according to claim 10 wherein the optical brightener of formula (1) is used in an amount from 0.05 to 0.5% by weight of white pigment.
